(19) United States
(12) Patent Application Publication
(10) Pub. No.: US 2025/0033507 A1
(43) Pub. Date: Jan. 30, 2025

(54) SMART ELECTRIC VEHICLE CHARGING STATION SYNCHRONIZATION

(71) Applicant: Sony Group Corporation, Tokyo (JP)

(72) Inventors: Tatsuya Yamazaki, Tokyo (JP); Tetsugoro Ihara, Tokyo (JP); Koji Nagata, Tokyo (JP); Naomasa Takahashi, Tokyo (JP); Tatsushi Nashida, Tokyo (JP); Tonni Sandager Larsen, San Diego, CA (US)

(73) Assignee: Sony Group Corporation, Tokyo (JP)

(21) Appl. No.: 18/227,706

(22) Filed: Jul. 28, 2023

(51) Int. Cl. B60L 53/62; B60L 53/68; H04N 21/414

(52) U.S. Cl. CPC B60L 53/62; B60L 53/68; H04N 21/41422; B60L 2240/70; B60L 2250/16

(57) ABSTRACT

Implementations generally relate to electric vehicle charging station synchronization. In some implementations, a method includes computing a target charging time to charge a battery of an electric vehicle. The method further includes computing a total play length of one or more media items. The method further includes synchronizing the target charging time with the total play length. The method further includes playing the one or more media items in the electric vehicle while the battery of the electric vehicle is being charged.

### BACKGROUND

The world is facing serious problems of global warming and limited oil resources and has begun to recognize it is very difficult to continue using internal combustion vehicle (ICVs). A dramatic shift to electric vehicles (EVs) is expected to continue into the future. On the other hand, challenges of driving range, charging infrastructure, and charging time have limited the widespread penetration of EVs. For example, in the US, EV charging stations are mainly located in urban areas on the east and west coasts. Consequently, there are many EV dead zones (e.g., a lack of EV charging stations), which makes long-distance cruising difficult. There are many built-in garages at home where people can charge EVs, which are generally used for city driving.

In Europe, EV charging at home is not available, whereas EV charging at street parking or carports is common. EV charging stations are being installed, but currently 70% of them are concentrated in Germany, France, and the Netherlands, which has made travel around the Europe by EV difficult. In China, the most advanced EV country in the world, the ratio of EVs to EV charging stations is still not sufficient at 3:1. In Japan, EV charging stations are mainly located in urban areas as in the US, and people cannot charge EVs at home. As such, the EV has not started to penetrate the world market. In order to solve these issues, countries are starting to enact national policies that provide incentives for widespread use and investment in the development of EV charging stations.

### SUMMARY

Implementations generally relate to smart electric vehicle charging station synchronization. In some implementations, a system includes one or more processors, and includes logic encoded in one or more non-transitory computer-readable storage media for execution by the one or more processors. When executed by the one or more processors, the logic is operable to cause the one or more processors to perform operations including: computing a target charging time to charge a battery of an electric vehicle; computing a total play length of one or more media items; synchronizing the target charging time with the total play length; and playing the one or more media items in the electric vehicle while the battery of the electric vehicle is being charged.

With further regard to the system, in some implementations, the one or more media items are associated with one or more of movie media items and interactive gaming media items. In some implementations, the target charging time is substantially a same as the total play length. In some implementations, the target charging time is based on the total play length. In some implementations, the total play length is based on the target charging time. In some implementations, the logic when executed is further operable to cause the one or more processors to perform operations including controlling one or more charging parameters at an electric vehicle charging station based one or more of the target charging time and the total play length.

In some implementations, a non-transitory computer-readable storage medium with program instructions thereon is provided. When executed by the one or more processors, the instructions are operable to cause the one or more processors to perform operations including: computing a target charging time to charge a battery of an electric vehicle; computing a total play length of one or more media items; synchronizing the target charging time with the total play length; and playing the one or more media items in the electric vehicle while the battery of the electric vehicle is being charged.

With further regard to the computer-readable storage medium, in some implementations, the one or more media items are associated with one or more of movie media items and interactive gaming media items. In some implementations, the target charging time is substantially a same as the total play length. In some implementations, the target charging time is based on the total play length. In some implementations, the total play length is based on the target charging time. In some implementations, the instructions when executed are further operable to cause the one or more processors to perform operations including controlling one or more charging parameters at an electric vehicle charging station based one or more of the target charging time and the total play length. In some implementations, the instructions when executed are further operable to cause the one or more processors to perform operations including playing the one or more media items in the electric vehicle while the battery of the electric vehicle is being charged and while the electric vehicle is parked in an enclosed area.

In some implementations, a method includes: computing a target charging time to charge a battery of an electric vehicle; computing a total play length of one or more media items; synchronizing the target charging time with the total play length; and playing the one or more media items in the electric vehicle while the battery of the electric vehicle is being charged.

With further regard to the method, in some implementations, the one or more media items are associated with one or more of movie media items and interactive gaming media items. In some implementations, the target charging time is substantially a same as the total play length. In some implementations, the target charging time is based on the total play length. In some implementations, the total play length is based on the target charging time. In some implementations, the method further includes controlling one or more charging parameters at an electric vehicle charging station based one or more of the target charging time and the total play length.

A further understanding of the nature and the advantages of particular implementations disclosed herein may be realized by reference of the remaining portions of the specification and the attached drawings.

### BRIEF DESCRIPTION OF THE DRAWINGS

FIG. 1 is a block diagram of an example environment for smart electric vehicle charging station synchronization, which may be used for implementations described herein.

FIG. 2 is a block diagram of an example environment for providing a realistic drive simulation, which may be used for implementations described herein.

FIG. 3 is an example flow diagram for providing electric vehicle charging station synchronization, according to some implementations.

FIG. 4 is a timing diagram showing example target charging times being based on total play lengths, according to some implementations.

FIG. 5 is a timing diagram showing example total play lengths being based on a target charging time, according to some implementations.

FIG. 6 is a side-view diagram showing an example environment including an enclosed area for a parked electric vehicle, according to some implementations.

FIG. 7 is a rear-view diagram showing an example environment including an enclosed area for a parked electric vehicle, according to some implementations.

FIG. 8 is a block diagram of an example network environment, which may be used for some implementations described herein.

FIG. 9 is a block diagram of an example computer system, which may be used for some implementations described herein.

### DETAILED DESCRIPTION

Implementations described herein enable, facilitate, and encourage electric vehicle (EV) charging by providing smart electric vehicle charging station synchronization. Implementations described herein address various challenges of EV charging. For example, it takes 6 to 30 hours to fully charge a Tesla Model S with a Level 2 EV charger, which is expected to become the primary EV charger on the market in the near future. It takes 0.5 to 3 hours to fully charge Tesla Model S with Level 3 EV charger such as Tesla's Supercharger. On the other hand, an internal combustion vehicle (ICV) takes only up to 5 minutes to fill up.

To enhance the transition from ICV to EV, it is essential to consider improvements regarding traffic congestion, charging experience, and battery treatment. For example, continuous use of Level 3 charger causes batteries to deteriorate faster. Motivating people to visit and spend time at EV charging stations that may be in less congested locations is challenging as such EV charging stations are farther away from main roadways. There is a trend for EV charging stations being installed at restaurants, in shopping malls, and at entertainment facilities, etc., to attract customers. Implementations described herein address these challenges by enhancing in-car entertainment while charging.

As described in more detail herein, in various implementations, a system computes a target charging time to charge a battery of an electric vehicle. The system then computes a total play length of one or more media items. The system then synchronizes the target charging time with the total play length. The system then plays the one or more media items in the electric vehicle while the battery of the electric vehicle is being charged. In various implementations, such media items include simulated driving experiences in the form of video games. Such video games may include missions that a user may experience. The system provides realistic driving experiences using video displays that surround the user, as well as using haptic feedback (e.g., vibrations) that simulate tires of the car hitting bumps on road, etc.

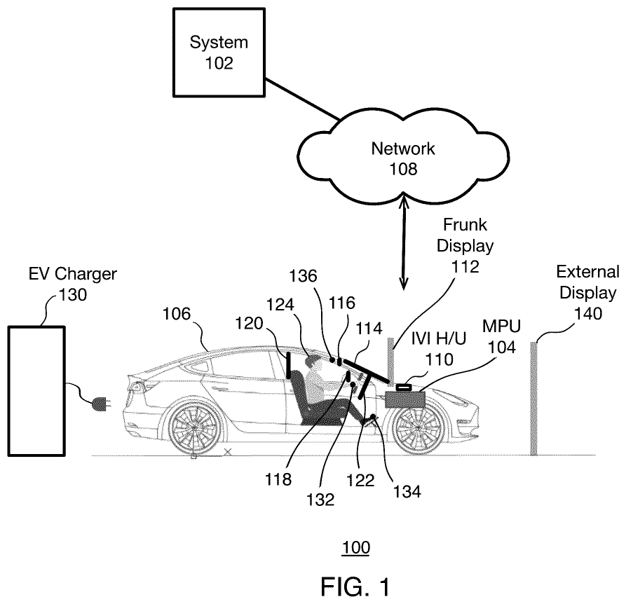

FIG. 1 is a block diagram of an example environment for smart electric vehicle charging station synchronization, which may be used for implementations described herein. In various implementations, an environment 100 is a simulation environment that includes a system 102, which communicates with a media device or media box 104 of a vehicle 106 via a network 108. Media box 104 also be referred to as a multimedia plug-in unit (MPU) 104. As such, the terms media box and MPU may be used interchangeably. In various implementations, media box 104 may be implemented with an in-vehicle infotainment (IVI) head unit (H/U) system, or IVI H/U 110. In some implementations, a head unit (H/U) may be worn regardless the original equipment manufacturer (OEM), installer, user, etc.

In various implementations, media box 104 and IVI H/U 110 are configured to be stored in the frunk of vehicle 106. A frunk may be defined as a storage space or trunk that is positioned in the front of a vehicle rather than in the rear of the vehicle. Frunks are common in vehicles such as electric vehicles, which do not typically have an engine under the front hood. In various implementations, media box 104 is not limited to storage in the frunk and alternatively may be positioned anywhere in the vehicle.

In various implementations, media box 104 be integrated with a frunk display 112, as well as with other internal or interior displays. For example, such other interior displays may include a windshield display 114, rear-view mirror display 116, side-view mirror displays 118 (only one shown for ease of illustration), a rear-window display 120, and a dash panel display 122. As described in more detail herein, these displays provide a user 124 with a realistic representation of the virtual scenery, including any virtual road or track.

As indicated above, system 102 communicates with media box 104 and/or with IVI H/U 110 associated with media box 104 via network 108. Network 108 may be any suitable communication network or combination of networks such as a Bluetooth network, a Wi-Fi network, the Internet, a 5G or 6G+ network, a satellite constellation network, etc. Also shown is a frunk display 112 positioned in front of user 124 seated in vehicle 106.

In various implementations, system 102 may send or downstream simulation data to media box 104 and/or to IVI H/U 110 associated with media box 104. Also, system 102 may receive or upstream behavior analytics data including UI data, sensor data, video data, audio data, and metadata from media box 104 and/or from IVI H/U 110.

System 102 presents visual driving information to user 124 via frunk display 110 and/or other displays shown. For example, system 102 may send a video stream to frunk display 112 directly or via media box 104. In various implementations, the video stream may contain audio, video, metadata, etc. The video stream utilizes audio, video, and metadata to show virtual scenery as vehicle 106 virtually travels along a driving route or driving track. The terms driving route, driving track, and track may be used interchangeably.

As described in more detail herein, in various implementations, the system may track environmental information (e.g., roads/tracks, road conditions, etc.), behavior of user, vehicle performance, and other associated information while the user operates the vehicle during normal, real-world driving on an actual road. In various implementations described herein, the system monitors and stores such information for future simulated driving experiences. As described in more detail herein, the system may enable the user to earn and accumulate virtual points or credit based on good driving behavior. The system enables the user to redeem or spend the virtual points on a variety of items such. as EV charging time, media items for consumption during charging, etc.

In various implementations, during simulated driving experiences, vehicle 106 remains parked. For example, vehicle 106 may be parked at an electric vehicle (EV charger 130. Such an EV charger 103 may be located at a charging station at home, along the road, at a building such as a work campus, shopping mall, government building, etc.

In various implementations, system 102 may decouple the wheels of the vehicle such that the vehicle remains parked regardless of the vehicle control input provided by the user (e.g., stepping on the accelerator, etc.). During simulated driving experiences, the system monitors the behavior of user, including movements of the user and information associated with vehicle controls manipulated by the user.

As shown, simulation environment 100 includes in-cabin sensors 132, 134, and 136. In various implementations, the system may utilize sensors 132, 134, and 136 to monitor the behavior and actions of user 124 during simulated driving experiences, as well as during actual driving experiences. In various implementations, sensors 132, 134, and 136 may include electromyography (EMG) sensors, image sensors such as a time-of-flight (ToF) sensors, etc., and any combination thereof.

The EMG sensors are contact sensors in that EMG sensors make contact with a body part of the user. For example, EMG sensors such as sensors 132 and 134 may be respectively attached to the hands and feet of the user. For ease of illustration, two EMG sensors are shown. Other EMG sensors may also be attached to the user at various locations on the body of the user, depending on the specific implementation. For example, EMG sensors may also be attached to the head of the user, elbows of the user, torso of the user, knees of the user, etc.

The ToF sensors such as sensor 136 are non-contact sensors in that ToF sensors do not make contact with the user. In various implementations, the system utilizes sensors such as ToF sensors to measure distances that different parts of the user in the cab of the vehicle. For ease of illustration, one ToF sensor is shown. Other ToF sensors may also be positioned at various locations in the cabin. In this example implementation, ToF sensor 136 is positioned at or close to the rear-view mirror of the vehicle. ToF sensors may be positioned at other locations within the cab of the vehicle. For example, ToF sensors may be attached around the steering wheel, to the rear-view mirrors, to the doors, to the ceiling, in the foot well of the driver, in one or more other foot wells, etc., depending on the implementation.

The number of EMG sensors and ToF sensors used may vary, depending on the particular implementation. For example, while two EMG sensors 131 and 134 and one ToF sensor 136 are shown, these sensors may represent any number of EMG sensors and ToF sensors, depending on the particular implementation.

In various implementations, the interior or in-cabin sensors 132, 134, and 136 monitor the condition of the user, and may also monitor condition of other vehicle occupants. For example, the system may monitor facial expressions and gestures to determine the driver's level of concentration and fatigue, etc. As indicated herein, the system utilizes in-cabin sensors such as EMG sensors and/or ToF sensors for both simulated and real driving scenarios. In various implementations, the system synchronizes data from one or more in-cabin images of the user, data including personalization parameters detected by one or more EMG sensors, and data from one or more ToF sensors. In some implementations, the system may process computations performed by some in-cabin sensors. In various implementations, the system processes such data described herein to detect key human behavior of the user. The system may also process such data for user personalization, driver training, road warnings, etc.

Also shown is an exterior or external display 140, which may be used in addition to other displays described herein. Being located on the exterior also allows for a bigger display, which is better for the eyes. Any additional interior displays facilitate the system in matching real and virtual cognition information. In various implementations, system 102 may present visual driving information to user 124 via external display 140 as with other displays shown. For example, system 102 may send a video stream to external display 140 directly or via media box 104. In various implementations, the video stream may contain audio, video, metadata, etc. The video stream utilizes audio, video, and metadata to show virtual scenery as vehicle 106 virtually travels along a driving route or driving track.

Frunk display 112 and other internal displays, and external display 140 may display the same content or information. In various implementations, the pixel density of the various displays and brightness of external display 140 are sufficient to maintain a minimum level of reality (e.g., more realistic driving experience, etc.). Also, in various implementations, the system adjusts the angle or perspective of the content displayed for frunk display, internal displays, and external display 140 independently. This facilitates system 102 in simulating a “horizontal level” as the user would expect.

Although implementations disclosed herein are described in the context of a car, the implementations may also apply to other types of vehicles (e.g., trucks, sport utility vehicles, etc.), as well as other modes of transportation such as water vehicles (e.g., boats, etc.) and air vehicles (e.g., planes, drones, etc.). In various implementations, the vehicle is an electric vehicle. In some implementations, the vehicle may be a hybrid vehicle. In some implementations, the vehicle may be a gas-powered vehicle.

In various implementations, environment 100 may not have all of the components shown and/or may have other elements including other types of elements instead of, or in addition to, those shown herein. Such variations also apply to other figures described herein.

While system 102 performs implementations described herein, in other implementations, any suitable component or combination of components associated with system 102 or any suitable processor or processors associated with system 102 may facilitate performing the implementations described herein.

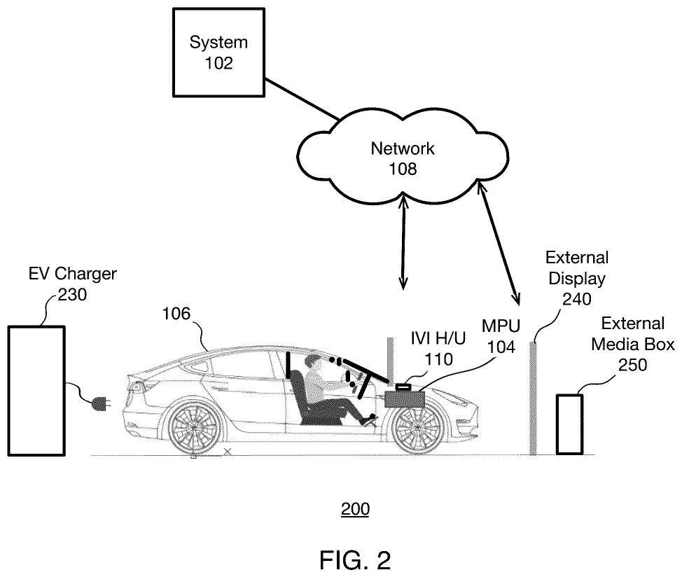

FIG. 2 is a block diagram of an example environment for providing a realistic drive simulation, which may be used for implementations described herein. In various implementations, environment 200 is a simulation environment that includes system 102 and network 108. Also shown are media box 104 and IVI H/U 110 of a vehicle 106. The remaining features of vehicle 106 are similar to those shown in FIG. 1. Also shown are an EV charger 230 and an exterior or external media display 240.

A difference between environment 100 of FIG. 1 and environment 200 of FIG. 2 is that environment 200 of FIG. 2 also includes external media box 250. In various implementations, system 102 may present visual driving information to the user via external display 240 as with other displays shown. For example, system 102 may send a video stream to external display 240 directly or via media box 250. In various implementations, the video stream may contain audio, video, metadata, etc. The video stream utilizes audio, video, and metadata to show virtual scenery as vehicle 106 virtually travels along a driving route or driving track.

In some implementations, external media box 250 may send a video cast to external display 240 for video mirroring. In some scenarios where the frunk display or internal displays are not available, the system may send the video stream directly to external display 240 and/or to IVI H/U 110.

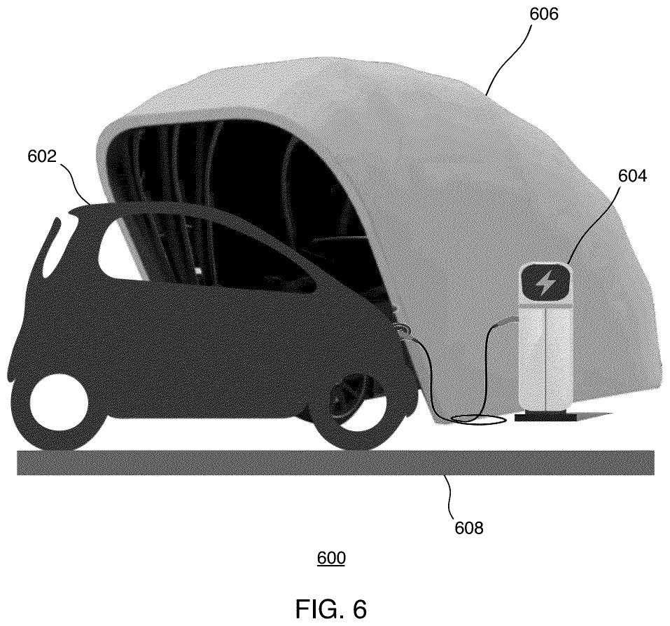

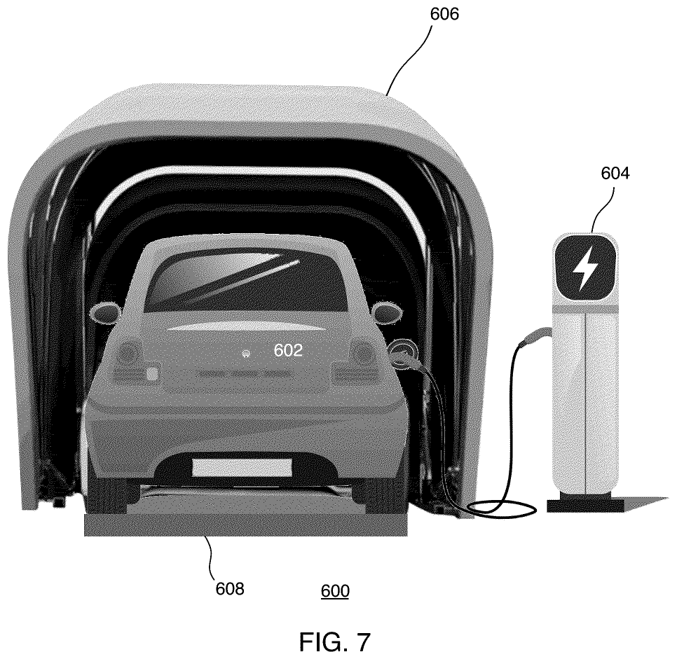

In some implementations, external display 240 may be a wall mounted display having sensors for signal processing. In some implementations, external display 240 may be a part of a larger external visual or video system such as in an enclosed area. Example implementations directed to enclosed areas associated with EV chargers are described herein, in FIGS. 6 and 7, for example. In various implementations, system 102 may utilize a sensor on the vehicle and on and/or around external display 240. System 102 may then detect the distance between the vehicle and display 240. The sensor on the vehicle may be located at various locations. System 102 may then ascertain the distance between the front of the vehicle and external display 240. The system may then provide parking assistance to the user or even automate parking for the user. In some implementations, the system may display virtual driving assist information on external display 240 (e.g., green light for approaching, yellow light for slowing to stop, red light for stopping, etc.).

In this example implementation, vehicle 106 is parked at an EV charger 230. EV charger 230 may be located at a charging station at home, along the road, at a building such as a work campus, shopping mall, government building, etc.

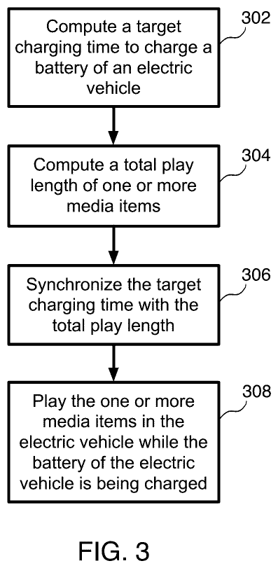

FIG. 3 is an example flow diagram for providing electric vehicle charging station synchronization, according to some implementations. Referring to both FIGS. 1 and 3, a method is initiated at block 302, where a system such as system 102 computes a target charging time to charge a battery of an electric vehicle. In various implementations, the system calculating optimal charging times and amount of charge based on battery degradation level, and guides the user with regard to appropriate charging timing and charging.

In various implementations, the system may guide the user to appropriate charging station based on the user's status, preference, and behavioral patterns. The system may guide the user as to how to spend time at a given charging station, and calculates the appropriate timing and appropriate amount of charge based on the user's behavior patterns or activities and/or preferences. The system may set the car navigation system to generate a route guide and may link the guide to various services.

At block 304, the system computes a total play length of one or more media items. In some implementations, the total play length may be based on play lengths of one or more selected media items. For example, the total play length may be a sum of play lengths of the one or more selected media items. In various implementations, one or more of the media items are associated with one or more of movie media items and interactive gaming media items. For example, movie media items may include feature films, short films, and other videos, etc. Interactive gaming media items may include video games such as games for simulating driving experiences. As indicated herein, the system enables a user perform simulated driving using actual controls of the car in combination with various video displays to show virtual driving routes and environments.

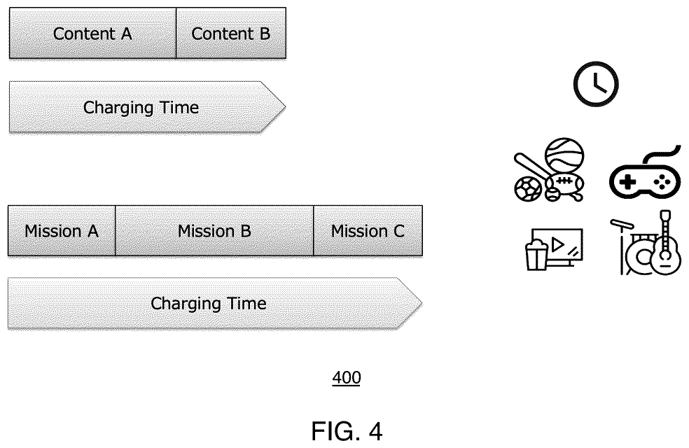

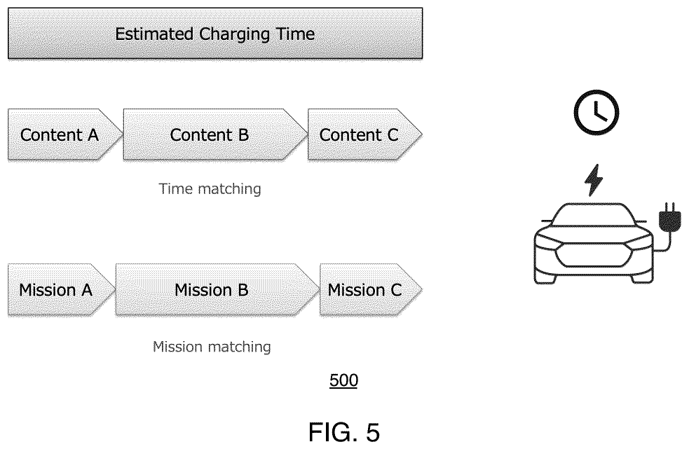

At block 306, the system synchronizes the target charging time with the total play length. In various implementations, the target charging time is substantially the same as the total play length. In some implementations, the target charging time is based on input from a user of the electric vehicle. In some implementations, the input from the user of the electric vehicle is the target charging time. In some implementations, the input from the user of the electric vehicle is the one or more selected media items. Example implementations directed to synchronization of target charging times with the total play lengths are described in more detail herein, in FIGS. 4 and 5, for example.

At block 308, the system plays the one or more media items in the electric vehicle while the battery of the electric vehicle is being charged. Playing the media items encourage the user to spend more time being entertained in the car during charging. The more time permitted for charge times increases the battery life. In some implementations, the system enables the user to earn and accumulate virtual points to be spent in the future in the form of credits. In some implementations, the system enables the user to transfer such credits to other users. Example implementations directed to earning and spending virtual points are described in more detail below.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

FIG. 4 is a timing diagram showing example target charging times being based on total play lengths, according to some implementations. Shown at the upper portion of FIG. 4 are two media items Content A followed by Content B and a target charging time. As shown, in this example, the target charging time is based on the total play length of Content A and Content B. In this example implementation, the media items may be referred to as lean-back media items in that the user can lean back and enjoy items such as feature films, short films, dramas, etc. The system determines the total play length of Content A and the total play length of Content B, which may be based on any techniques described herein. The system then adds them together to get the total play length. The system adjusts the target charging time to the total play length.

Shown at the lower portion of FIG. 4 are three media items Mission A followed by Mission B followed by Mission C and a target charging time. As shown, in this example, the target charging time is based on the total play length of media items Mission A, Mission B, and Mission C. In this example implementation, the media items may be referred to as lean-forward media items in that the user can lean forward and enjoy items such as games, live concerts, sports, etc. Games may include driving simulation games, where the user may use the actual controls of the car (e.g., steering wheel, gas pedal, break pedal, etc.) to play games, go on missions, etc. The system determines the total play length of Mission A, the total play length of Mission B, and the total play length of Mission C, which may be based on any techniques described herein. The system then adds them together to get the total play length. As shown in FIG. 4, the system adjusts the target charging time to the total play length.

FIG. 5 is a timing diagram showing example total play lengths being based on a target charging time, according to some implementations. Shown at the upper portion of FIG. 5 is an estimated or target charging time, and three media items Content A followed by Content B followed by Content C. In various implementations, the total play length is based on the target charging time. In this example implementation, the media items may be referred to as lean-back media items in that the user can lean back and enjoy items such as feature films, short films, dramas, etc. In this example implementation, the system determines the estimated or target charging time based on any techniques described herein. For example, the system may measure the amount of charge remaining in the battery. In some implementations, the target charging time is based on a difference between a charge capacity of the battery and a remaining charge of the battery. The system determines the total play length of Content A, the total play length of Content B, and the total play length of Content C, which may be based on any techniques described herein. The system then adds them together to get the total play length. The system recommends media items that fit within the time frame of the target charging time.

Shown at the lower portion of FIG. 5 are three media items Mission A followed by Mission B followed by Mission C. In this example implementation, the media items may be referred to as lean-forward media items in that the user can lean forward and enjoy items such as games, live concerts, sports, etc. The system determines the total play length of Mission A, the total play length of Mission B, and the total play length of Mission C, which may be based on any techniques described herein. The system then adds them together to get the total play length. The system recommends media items that fit within the time frame of the target charging time.

In various implementations, the system controls one or more charging parameters at an electric vehicle charging station based one or more of the target charging time and the total play length. The system appropriately controls one or more charging parameters at an electric vehicle charging station, which is valuable to the user, as fast charging from empty to full damages the battery life. The charging parameters may include the type of charging (e.g., Level 2, Level 3, etc.), including the length of charging time, etc. EV batteries are generally Li-ion type, similar to smartphones and notebook PCs, and the deterioration varies greatly depending on how they are recharged and how often they are used, resulting in shorter durations. EV battery degradation also varies based on how long the battery is being charged and whether the charging is high-voltage, low-voltage, etc. For example, high-voltage fast charging degrades EV batteries, and low-voltage slow charging saves EV batteries). Accordingly, there are many issues to consider when charging EVs based on the condition of the battery, the frequency of charging, the amount of charge, etc. It is difficult for users to determine how often to go to a charging station, depending on location, charging time, etc. Also, simultaneous high-voltage fast charging for multiple cars at busy EV charging station may affect the power source side. In various implementations, the system may control and balance the charging load.

FIG. 6 is a side-view diagram showing an example environment 600 including an enclosed area for a parked electric vehicle, according to some implementations. Shown is a parked electric vehicle 602 that is being charged at an EV charger 604 underneath an enclosed area 606. In some implementations, environment 600 may include a motorized floor 608 for interactive effects. In various implementations, the system plays the one or more media items in electric vehicle 602 while the battery of electric vehicle 602 is being charged and while electric vehicle 602 is parked in enclosed area 606.

FIG. 7 is a rear-view diagram showing example environment 600 including an enclosed area for a parked electric vehicle, according to some implementations. Shown is parked electric vehicle 602 that is being charged at EV charger 604 underneath enclosed area 606, and motorized floor 608. The enclosed area also provides privacy for the user. In some implementations, the inside of the cover may present visual driving footage (e.g., using a projector, etc.). Motorized floor 608 may provide the user with a rumble effect to enhance the simulated driving experience.

As indicated herein, in various implementations, the system may enable the user to earn and accumulate virtual points or credits. The user may earn such points with actual driving behavior monitored while actually driving and uses car sensors described herein. The user may earn points with good driving behavior sponsored by insurance companies (e.g., driving at good speeds and distance, paying proper attention to the road, etc.). The user may also earn points by driving less congested routes sponsored by city planners. The user may also earn points by parking at a shopping mall or at specific shops sponsored by the malls/shops. For example, the user may also earn points by using specific car wash sponsored by the car wash owner. In contrast to earning points, in some implementations, the user may lose virtual points with bad driving behavior (enforced by insurance company), leave a car at charging station for too long (enforced by charging network).

The user may spend points to redeem various coupons, listening to radio stations without ads, etc. The user may also get free charging minutes at charging stations, receive free movies and game plays, etc., at interactive charging stations (e.g., play stations), receive spotify/carplay/special UI for a predetermined time period (e.g., a month, etc.) via in-vehicle upgrades/feature unlocks.

In various implementations, MPU 104 may function as an information hub via Wifi. For example, one or more smartphone-tethering communicating applications may be connected to one or more client devices such as smartphone, tablet, and laptop to control various content during any remaining charging time.

In various implementations, the system enables a charging station to function as an information hub, where the system provides via the charging station personalized playlists and tour plans based on the location and charging time. The system may also provide a user with rewards for items purchased while charging. The system provides various activities via a charging station. For example, the system may provide destination lists based on current location information, generate routes according to distances from the current location information, etc.

Implementations described herein provide various benefits. For example, implementations entertain a user while charging his or her car. Implementations described herein also enable the user to be entertained using driving simulation media. Playing the media items encourage the user to spend more time on entertainment in the car while charging. The more time permitted for charge time increases the battery life. Implementations provide individual optimization of experiences in the in-cabin environment during charging. Implementations utilize virtual reality cockpit experiences at charging stations to playback drive recordings on large screens during charging.

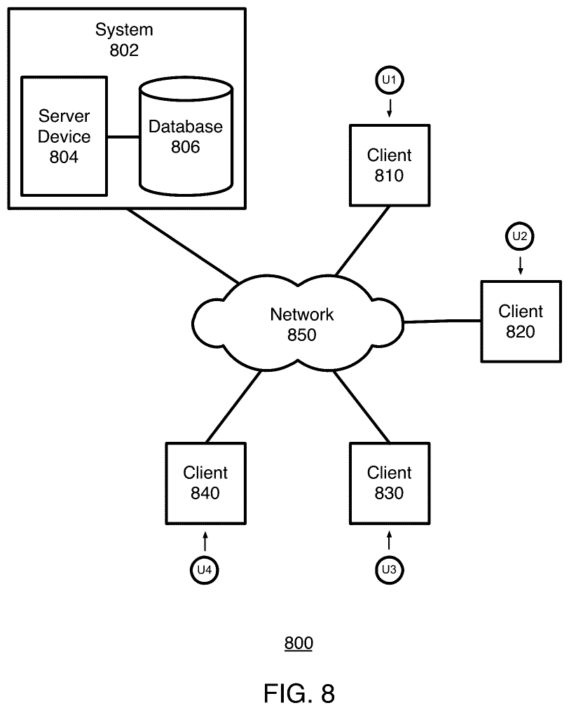

FIG. 8 is a block diagram of an example network environment 800, which may be used for some implementations described herein. In some implementations, network environment 800 includes a system 802, which includes a server device 804 and a database 806. For example, system 802 may be used to implement system 102 of FIG. 1, as well as to perform implementations described herein. Network environment 800 also includes client devices 810, 820, 830, and 840, which may communicate with system 802 and/or may communicate with each other directly or via system 802. Network environment 800 also includes a network 850 through which system 802 and client devices 810, 820, 830, and 840 communicate. Network 850 may be any suitable communication network such as a Wi-Fi network, Bluetooth network, the Internet, etc.

For ease of illustration, FIG. 8 shows one block for each of system 802, server device 804, and network database 806, and shows four blocks for client devices 810, 820, 830, and 840. Blocks 802, 804, and 806 may represent multiple systems, server devices, and network databases. Also, there may be any number of client devices. In other implementations, environment 800 may not have all of the components shown and/or may have other elements including other types of elements instead of, or in addition to, those shown herein.

While server device 804 of system 802 performs implementations described herein, in other implementations, any suitable component or combination of components associated with system 802 or any suitable processor or processors associated with system 802 may facilitate performing the implementations described herein.

In the various implementations described herein, a processor of system 802 and/or a processor of any client device 810, 820, 830, and 840 cause the elements described herein (e.g., information, etc.) to be displayed in a user interface on one or more display screens.

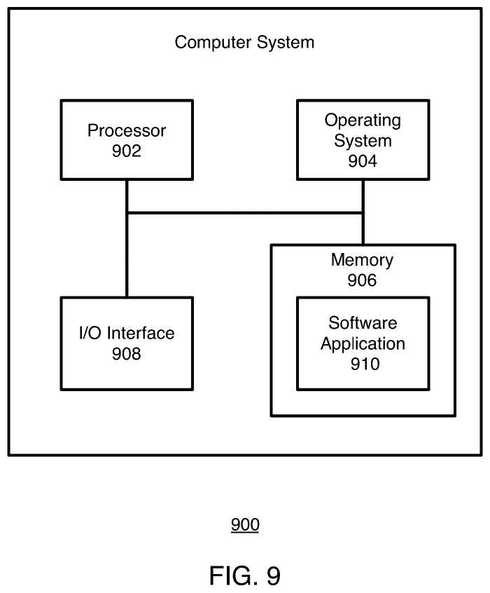

FIG. 9 is a block diagram of an example computer system 900, which may be used for some implementations described herein. For example, computer system 900 may be used to implement server device 804 of FIG. 8 and/or system 102 of FIG. 1, as well as to perform implementations described herein. In some implementations, computer system 900 may include a processor 902, an operating system 904, a memory 906, and an input/output (I/O) interface 908. In various implementations, processor 902 may be used to implement various functions and features described herein, as well as to perform the method implementations described herein. While processor 902 is described as performing implementations described herein, any suitable component or combination of components of computer system 900 or any suitable processor or processors associated with computer system 900 or any suitable system may perform the steps described. Implementations described herein may be carried out on a user device, on a server, or a combination of both.

Computer system 900 also includes a software application 910, which may be stored on memory 906 or on any other suitable storage location or computer-readable medium. Software application 910 provides instructions that enable processor 902 to perform the implementations described herein and other functions. Software application may also include an engine such as a network engine for performing various functions associated with one or more networks and network communications. The components of computer system 900 may be implemented by one or more processors or any combination of hardware devices, as well as any combination of hardware, software, firmware, etc.

For ease of illustration, FIG. 9 shows one block for each of processor 902, operating system 904, memory 906, I/O interface 908, and software application 910. These blocks 902, 904, 906, 908, and 910 may represent multiple processors, operating systems, memories, I/O interfaces, and software applications. In various implementations, computer system 900 may not have all of the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C #, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

What is claimed is:

1. A system comprising:
one or more processors; and
logic encoded in one or more non-transitory computer-readable storage media for execution by the one or more processors and when executed operable to cause the one or more processors to perform operations comprising:
computing a target charging time to charge a battery of an electric vehicle;
computing a total play length of one or more media items;
synchronizing the target charging time with the total play length; and
playing the one or more media items in the electric vehicle while the battery of the electric vehicle is being charged.

2. The system of claim 1, wherein the one or more media items are associated with one or more of movie media items and interactive gaming media items.

3. The system of claim 1, wherein the target charging time is substantially a same as the total play length.

4. The system of claim 1, wherein the target charging time is based on the total play length.

5. The system of claim 1, wherein the total play length is based on the target charging time.

6. The system of claim 1, wherein the logic when executed is further operable to cause the one or more processors to perform operations comprising controlling one or more charging parameters at an electric vehicle charging station based one or more of the target charging time and the total play length.

7. The system of claim 1, wherein the logic when executed is further operable to cause the one or more processors to perform operations comprising playing the one or more media items in the electric vehicle while the battery of the electric vehicle is being charged and while the electric vehicle is parked in an enclosed area.

8. A non-transitory computer-readable storage medium with program instructions stored thereon, the program instructions when executed by one or more processors are operable to cause the one or more processors to perform operations comprising:
computing a target charging time to charge a battery of an electric vehicle;
computing a total play length of one or more media items;
synchronizing the target charging time with the total play length; and
playing the one or more media items in the electric vehicle while the battery of the electric vehicle is being charged.

9. The computer-readable storage medium of claim 8, wherein the one or more media items are associated with one or more of movie media items and interactive gaming media items.

10. The computer-readable storage medium of claim 8, wherein the target charging time is substantially a same as the total play length.

11. The computer-readable storage medium of claim 8, wherein the target charging time is based on the total play length.

12. The computer-readable storage medium of claim 8, wherein the total play length is based on the target charging time.

13. The computer-readable storage medium of claim 8, wherein the instructions when executed are further operable to cause the one or more processors to perform operations comprising controlling one or more charging parameters at an electric vehicle charging station based one or more of the target charging time and the total play length.

14. The computer-readable storage medium of claim 8, wherein the instructions when executed are further operable to cause the one or more processors to perform operations comprising playing the one or more media items in the electric vehicle while the battery of the electric vehicle is being charged and while the electric vehicle is parked in an enclosed area.

15. A computer-implemented method comprising:
computing a target charging time to charge a battery of an electric vehicle;
computing a total play length of one or more media items;
synchronizing the target charging time with the total play length; and
playing the one or more media items in the electric vehicle while the battery of the electric vehicle is being charged.

16. The method of claim 15, wherein the one or more media items are associated with one or more of movie media items and interactive gaming media items.

17. The method of claim 15, wherein the target charging time is substantially a same as the total play length.

18. The method of claim 15, wherein the target charging time is based on the total play length.

19. The method of claim 15, wherein the total play length is based on the target charging time.

20. The method of claim 15, further comprising controlling one or more charging parameters at an electric vehicle charging station based one or more of the target charging time and the total play length.
